(19) United States
(12) Patent Application Publication
(10) Pub. No.: US 2014/0231059 A1
(43) Pub. Date: Aug. 21, 2014

(54) HEAT EXCHANGER

(71) Applicant: HAMILTON SUNDSTRAND CORPORATION, (US)

(72) Inventors: Wallace T. Nietupski, Wilbraham, MA (US); Steven D. Army, Enfield, CT (US); Kurt L. Stephens, Enfield, CT (US); Michael Doe, Jr., Southwick, MA (US)

(73) Assignee: HAMILTON SUNDSTRAND CORPORATION, Windsor Locks, CT (US)

(21) Appl. No.: 13/771,179

(22) Filed: Feb. 20, 2013

(51) Int. Cl. B64D 13/00

(52) U.S. Cl. CPC B64D 13/006
USPC 165/181; 29/890.035

(57) ABSTRACT

A heat exchanger assembly for an inert gas system includes a ram air inlet flange, a ram air outlet flange, and a core coupled to the ram air inlet flange and the ram air outlet flange. The core includes a fin assembly having a plurality of hot layers and ram air layers. The hot layers have an effective hot flow length, the ram air layers have an effective cold flow length, and the fin assembly has a no flow length. A ratio of the effective hot flow length to the effective cold flow length is between 9.23 and 10.32. A ratio of the no flow length to the cold flow length is between 21.86 and 25.23.

### BACKGROUND OF THE INVENTION

The subject matter disclosed herein relates to heat exchangers. More specifically, the subject disclosure relates to a heat exchanger for an aircraft inert gas system.

Many types of aircraft use ram air flow for various purposes, such as in cooling systems for an aircraft. For example, ram air flow may be utilized to remove heat from various aircraft lubrication and electrical systems and/or used to condition aircraft cabin air. When the aircraft is in flight, the movement of the aircraft creates a sufficient source of ram air flow which can be used for the purposes described above. When the aircraft is on the ground or is operating at low speeds, a fan in the ram air cooling system is typically utilized to increase air flow to the cooling systems. Cooling flow is drawn through a ram inlet header and heat exchangers to a ram outlet header. The cooling flow can also directly supply cooling air for various components, such as fan and compressor bearings. A wide range of temperature and pressure combinations must be supported by components in a ram air cooling system to account for various loading conditions such as burst conditions, buckling conditions, acceleration, pressure cycling, and the like, while also controlling for weight within an aerospace environment.

### BRIEF DESCRIPTION OF THE INVENTION

According to one aspect, a heat exchanger assembly for an inert gas system is provided. The heat exchanger assembly includes a ram air inlet flange, a ram air outlet flange, and a core coupled to the ram air inlet flange and the ram air outlet flange. The core includes a fin assembly having a plurality of hot layers and ram air layers. The hot layers have an effective hot flow length, the ram air layers have an effective cold flow length, and the fin assembly has a no flow length. A ratio of the effective hot flow length to the effective cold flow length is between 9.23 and 10.32. A ratio of the no flow length to the cold flow length is between 21.86 and 25.23.

According to another aspect, a heat exchanger core for a heat exchanger assembly of an inert gas system is provided. The heat exchanger core includes a fin assembly having a plurality of hot layers and ram air layers. The hot layers have an effective hot flow length, the ram air layers have an effective cold flow length, and the fin assembly has a no flow length. A ratio of the effective hot flow length to the effective cold flow length is between 9.23 and 10.32. A ratio of the no flow length to the cold flow length is between 21.86 and 25.23.

According to a further aspect, a method of installing a heat exchanger assembly for an inert gas system in a ram air cooling system is provided. A ram air inlet flange of the heat exchanger assembly is coupled to an environmental control system heat exchanger pack of the ram air cooling system. A ram air outlet flange of the heat exchanger assembly is coupled to a ram outlet header of the ram air cooling system. A hot inlet of the heat exchanger assembly is coupled to an inlet conduit configured to provide engine bleed air. A hot outlet of the heat exchanger assembly is coupled to an outlet conduit configured to provide a cooled flow from the engine bleed air to an air separation module of the inert gas system. Cooling of the engine bleed air is provided by a core of the heat exchanger assembly that includes a fin assembly having a plurality of hot layers and ram air layers. The hot layers have an effective hot flow length, the ram air layers have an effective cold flow length, and the fin assembly has a no flow length. A ratio of the effective hot flow length to the effective cold flow length is between 9.23 and 10.32. A ratio of the no flow length to the cold flow length is between 21.86 and 25.23.

### BRIEF DESCRIPTION OF THE DRAWINGS

FIG. 1 is a schematic view of an embodiment of a ram air cooling system;

FIG. 2 is a perspective view of an embodiment of an inert gas system (IGS) heat exchanger assembly in the ram air cooling system of FIG. 1;

FIG. 3 is a side view of the IGS heat exchanger assembly of FIG. 1;

FIG. 4 is an end view of a fin assembly of a core of the IGS heat exchanger assembly of FIG. 1;

FIGS. 5A, 5B, and 5C depict various fins of the core of the IGS heat exchanger assembly of FIG. 1;

FIGS. 6A and 6B depict cold and hot flow paths through the core of the IGS heat exchanger assembly of FIG. 1; and

FIG. 7 is a perspective view of the fin assembly of the core of the IGS heat exchanger assembly of FIG. 1.

The detailed description explains embodiments of the invention, together with advantages and features, by way of example with reference to the drawings.

### DETAILED DESCRIPTION OF THE INVENTION

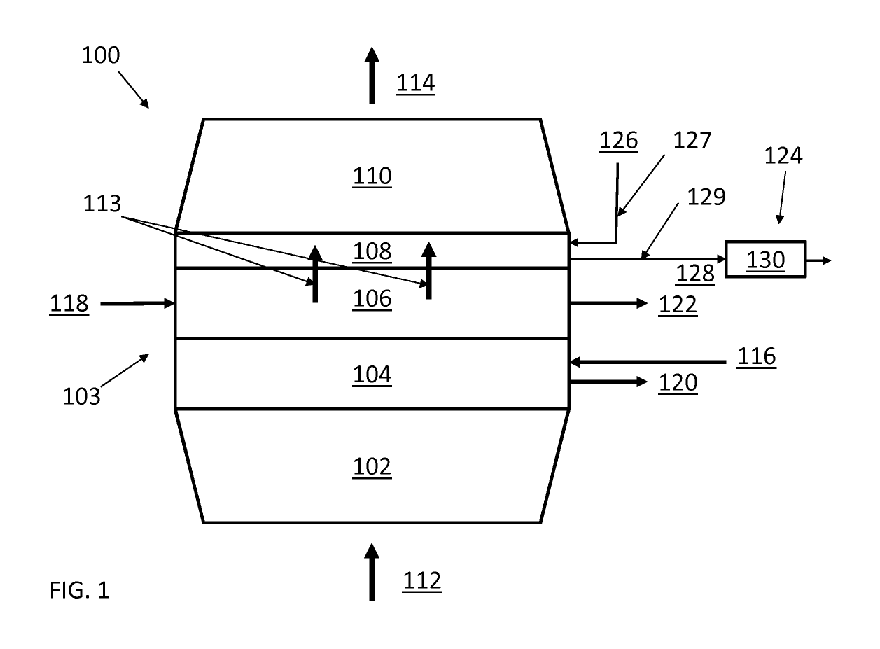

Shown in FIG. 1 is a schematic view of a ram air cooling system 100 for an aircraft environmental control system (ECS). The ram air cooling system 100 includes a ram inlet header 102, an ECS heat exchanger pack 103 that includes a pair of heat exchanger assemblies 104 and 106, an inert gas system (IGS) heat exchanger assembly 108, and a ram outlet header 110. Ram air 112 enters the ram air cooling system 100 through the ram inlet header 102, passes through the heat exchanger assemblies 104 and 106 of the ECS heat exchanger pack 103 as an intermediate ram air flow 113, continues through the IGS heat exchanger assembly 108, and exits through the ram outlet header 110 as an outlet flow 114. The ram air cooling system 100 may include other flow control features known in the art (not depicted), such as one or more fans, valves, inlet doors, outlet doors, sensors, and actuators.

The ECS heat exchanger pack 103 receives hot flows 116 and 118 and returns cooled flows 120 and 122. The cooled flows 120 and 122 can be used to cool various heat loads associated with the aircraft ECS. In exemplary embodiments, the IGS heat exchanger 108 is coupled to the ECS heat exchanger pack 103 in a compact envelope and is configured to receive the intermediate ram air flow 113. The IGS heat exchanger 108 is part of an inert gas system 124. The inert gas system 124 replaces flammable gas with non-flammable gas in aircraft fuel tanks (not depicted) to reduce fuel tank flammability. The IGS heat exchanger assembly 108 receives engine bleed air 126 from an inlet conduit 127 and provides a cooled flow 128 via an outlet conduit 129 to an air separation module 130 of the inert gas system 124. The IGS heat exchanger assembly 108 may cool the engine bleed air 126 as hot as about 497 degrees F. (about 258.3 degrees C.) down to the cooled flow 128 of about 180 degrees F. (about 82.2 degrees C.).

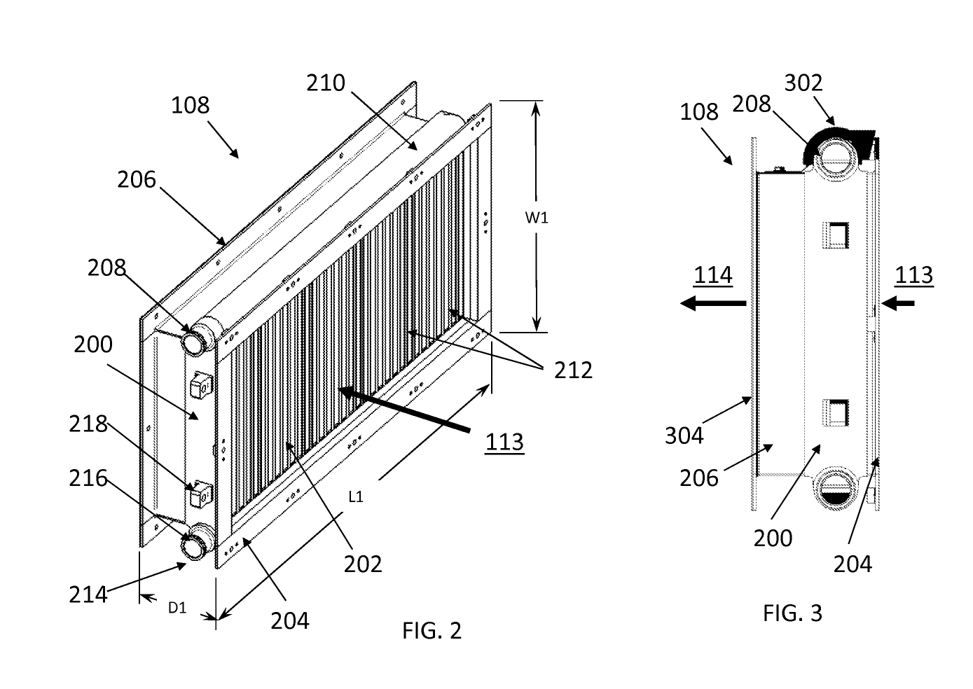

FIG. 2 is perspective view of an embodiment of the IGS heat exchanger assembly 108 of FIG. 1. The IGS heat exchanger assembly 108 includes a core 200 that includes a fin assembly 202. The core 200 is coupled to a ram air inlet flange 204 and a ram air outlet flange 206. The intermediate ram air flow 113 is received at the core 200 from the ECS heat exchanger pack 103 of FIG. 1 as a cold flow. A hot inlet 208 of the IGS heat exchanger assembly 108 is coupled to the inlet conduit 127 of FIG. 1 to receive the engine bleed air 126 of FIG. 1. A hot inlet header 210 receives the engine bleed air 126 of FIG. 1 from the hot inlet 208. A hot flow path is established from the hot inlet header 210 through a plurality of hot layers 212 to a hot outlet header 214 and out of a hot outlet 216 of the IGS heat exchanger assembly 108. The IGS heat exchanger assembly 108 may also include manufacturing lugs 218 that can be used to assist in the process of manufacturing and assembling the IGS heat exchanger assembly 108. In an exemplary embodiment, the IGS heat exchanger assembly 108 has a length (L1) of about 26.1 inches (66.294 cm) in a no-flow direction, a width (W1) of about 12.5 inches (31.75 cm) in a hot flow direction, and a depth of about 4.25 inches (10.795 cm) in a ram (cold) flow direction.

FIG. 3 is a side view of the IGS heat exchanger assembly 108. As can be seen in FIG. 3, the intermediate ram air flow 113 enters the ram air inlet flange 204-side of the IGS heat exchanger assembly 108, passes through the core 200, and exits the ram air outlet flange 206-side of the IGS heat exchanger assembly 108 as the outlet flow 114. Thermo insulation 302 can be installed proximate to the hot inlet 208 of the IGS heat exchanger assembly 108. A gasket 304 may be installed on the ram air outlet flange 206 such that the gasket 304 is between the ram air outlet flange 206 and the ram outlet header 110 of FIG. 1.

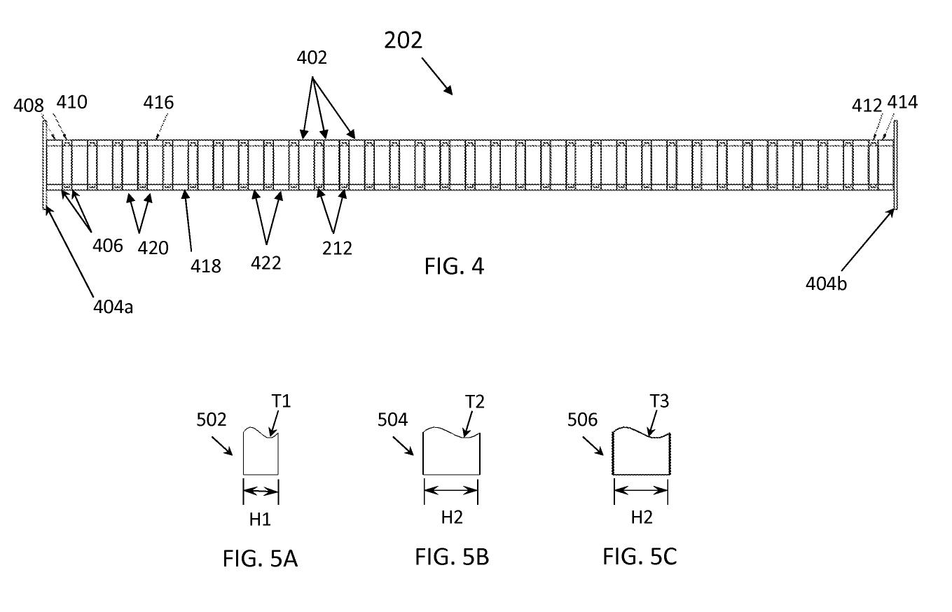

FIG. 4 is an end view of the fin assembly 202 of FIG. 2 in the IGS heat exchanger assembly 108 of FIG. 1. The fin assembly 202 includes a plurality of ram air layers 402 and hot layers 212 alternating between end sheets 404a and 404b. The ram air layers 402 are cold flow passages through the fin assembly 202, while the hot layers 212 are hot flow passages through the fin assembly 202. Alternating pairs of the ram air layers 402 and the hot layers 212 are separated by pairs of parting sheets 406. A first ram air layer 408 is proximate the end sheet 404a and a first hot layer 410. The ram air layers 402 and the hot layers 212 continue to alternate up to a thirty-third hot layer 412 and a thirty-fourth ram air layer 414, where the thirty-fourth ram air layer 414 is proximate the end sheet 404b. The ram air layers 402 between the first ram air layer 408 and a fifth ram air layer 416 include a plurality of cold thick layers 420. The ram air layers 402 between a sixth ram air layer 418 and the thirty-fourth ram air layer 414 include a plurality of cold thin layers 422. Accordingly, a ratio of the number of cold thin layers 422 to the cold thick layers 420 is 29:5, a ratio of the number of hot layers 212 to the cold thick layers 420 is 33:5, and a ratio of the number of hot layers 212 to the cold thin layers 422 is 33:29.

FIGS. 5A, 5B, and 5C depict examples of various fins of the fin assembly 202 of FIG. 2 in the IGS heat exchanger assembly 108 of FIG. 1. FIG. 5A is an example of a hot fin 502 having a hot fin height H1 of about 0.249 inches (0.6325 cm) and a hot fin thickness T1 of about 0.004 inches (0.01016 cm). FIG. 5B is an example of a cold thin fin 504 having a cold fin height H2 of about 0.425 inches (1.0795 cm) and a cold thin fin thickness T2 of about 0.008 inches (0.02032 cm). FIG. 5C is an example of a cold thick fin 506 having the cold fin height H2 and a cold thick fin thickness T3 of about 0.02 inches (0.0508 cm). In embodiments, a ratio of the cold fin height H2 to the hot fin height H1 is between 1.65 and 1.77. A ratio of a cold thick fin thickness T3 to the cold thin fin thickness T2 is between 2.29 and 2.74. A ratio of the cold thick fin thickness T3 to the hot fin thickness T1 is between 4.33and 5.86. A ratio of the cold thin fin thickness T2 to the hot fin thickness T1 is between 1.66 and 2.43.

A plurality of the hot fins 502 are incorporated in each of the hot layers 212 of FIG. 4. A plurality of the cold thin fins 504 are incorporated in each of the cold thin layers 422 of FIG. 4, and a plurality of the cold thick fins 506 are incorporated in each of the cold thick layers 420 of FIG. 4. The fins 502, 504, and 506 are all ruffled fins. A different fin distribution density may be incorporated between the hot fins 502 and the cold fins 504 and 506. In an embodiment, the hot fins 502 have a hot fin distribution density of about 13 fins per inch per layer (about 5 fins per cm per layer), and the cold fins 504 and 506 have a cold fin distribution density of about 8 fins per inch per layer (about 3 fins per cm per layer). Accordingly, a ratio of the hot fin distribution density to the cold fin distribution density is about 13:8.

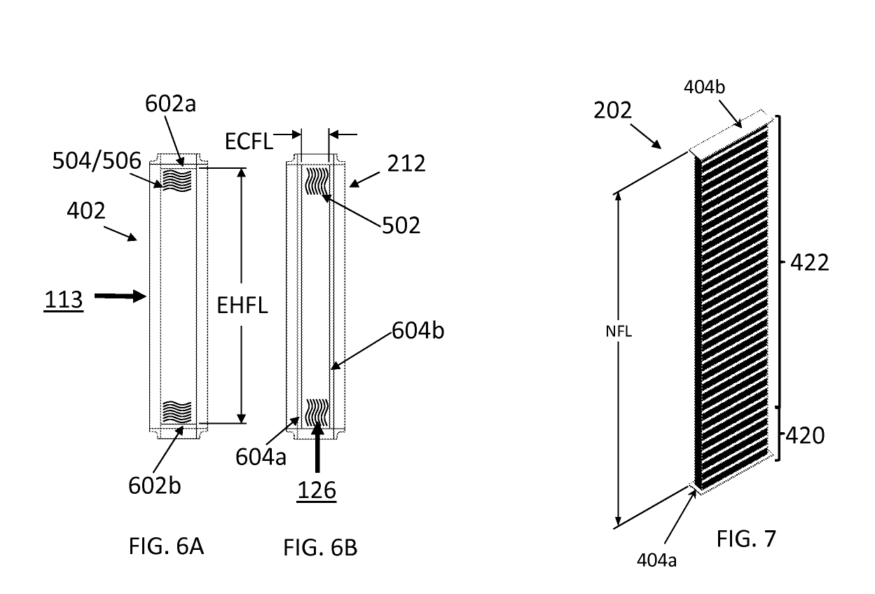

FIGS. 6A and 6B depict cold and hot flow paths through the core 200 of FIG. 2 of the IGS heat exchanger assembly 108 of FIG. 1. FIG. 6A depicts an example of one of the ram air layers 402 of FIG. 4 that includes either a plurality of the cold thin fins 504 or the cold thick fins 506 of FIGS. 5B and 5C. For example, where the ram air layer 402 is embodied as one of the cold thin layers 422, the cold thin fins 504 are included, and where the ram air layer 402 is embodied as one of the cold thick layers 420, the cold thick fins 506 are included. The cold layer 402 also includes a pair of closure bars 602a and 602b that provides an outer limit to define an effective hot flow length (EHFL) for the hot layer 212 of FIG. 6B as the intermediate ram air flow 113 is received in a cold flow path defined between the closure bars 602a and 602b. In an embodiment, the EHFL is about 9.75 inches (24.765 cm). A ratio of W1 of FIG. 2 to the EHFL is between 1.27 and 1.30.

FIG. 6B depicts an example of one of the hot layers 212 of FIG. 4 that includes a plurality of the hot fins 502 of FIG. 5A. The hot layer 212 also includes a pair of closure bars 604a and 604b that provides an outer limit to define an effective cold flow length (ECFL) for the cold layer 402 of FIG. 6A as the engine bleed air 126 is received in a hot flow path defined between the closure bars 604a and 604b. In an embodiment, the ECFL is about 1.00 inches (2.54 cm). Accordingly, a ratio of the EHFL of FIG. 6A to the ECFL is between 9.23 and 10.32. A ratio of D1 of FIG. 2 to the ECFL is between 4.00 and 4.53.

FIG. 7 is a perspective view of the fin assembly 202 of the core 200 of FIG. 2 of the IGS heat exchanger assembly 108 of FIG. 1. A ratio of the cold thin layers 422 to the cold thick layers 420 is visually depicted in FIG. 7. FIG. 7 further illustrates a non-flow length (NFL) defined between the pair of end sheets 404a and 404b. In an embodiment, the NFL is about 23.46 inches (59.59 cm). Accordingly, in view of the EHFL and ECFL as defined in FIGS. 6A and 6B, a ratio of the NFL to the EHFL is between 2.34 and 2.47, and a ratio of the NFL to the ECFL is between 21.86 and 25.23. A ratio of L1 of FIG. 2 to the NFL is between 1.08 and 1.14.

A process for installing the heat exchanger assembly 108 in the ram air cooling system 100 of FIG. 1 includes coupling the ram air inlet flange 204 of FIG. 2 of the IGS heat exchanger assembly 108 of FIG. 1 to the ECS heat exchanger pack 103 of FIG. 1 in the ram air cooling system 100 of FIG. 1. The gasket 304 of FIG. 3 may be installed between the ram air outlet flange 206 of FIG. 2 and the ram outlet header 110 of FIG. 1. The ram air outlet flange 206 is coupled to the ram outlet header 110 in the ram air cooling system 100. The hot inlet 208 of FIG. 2 of the IGS heat exchanger assembly 108 is coupled to the inlet conduit 127 of FIG. 1 that is configured to provide engine bleed air 126 of FIG. 1 to the IGS heat exchanger assembly 108. The hot outlet 216 of FIG. 2 of the IGS heat exchanger assembly 108 is coupled to the outlet conduit 129 of FIG. 1 that is configured to provide the cooled flow 128 of FIG. 1 from the engine bleed air 126 to the air separation module 130 of the inert gas system 124 of FIG. 1. Thermo insulation 302 of FIG. 3 may be installed proximate to the hot inlet 208 of the IGS heat exchanger assembly 108.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A heat exchanger assembly for an inert gas system, the heat exchanger assembly comprising:
a ram air inlet flange;
a ram air outlet flange; and
a core coupled to the ram air inlet flange and the ram air outlet flange, the core comprising a fin assembly of a plurality of hot layers and ram air layers, the hot layers having an effective hot flow length, the ram air layers having an effective cold flow length, and the fin assembly having a no flow length, wherein a ratio of the effective hot flow length to the effective cold flow length is between 9.23 and 10.32 and a ratio of the no flow length to the cold flow length is between 21.86 and 25.23.

2. The heat exchanger assembly of claim 1, wherein the hot layers comprise a plurality of hot fins, the ram air layers comprise a plurality of cold fins, and a ratio of cold fin height to a hot fin height is between 1.65 and 1.77.

3. The heat exchanger assembly of claim 1, wherein the hot layers comprise a plurality of hot fins having a hot fin distribution density, the ram air layers comprise a plurality of cold fins having a cold fin distribution density, and a ratio of the hot fin distribution density to the fin cold distribution density is 13:8.

4. The heat exchanger assembly of claim 1, wherein the ram air layers comprise a plurality of cold thin layers and cold thick layers, and a ratio of a number of the cold thin layers to the cold thick layers is 29:5.

5. The heat exchanger assembly of claim 4, wherein a ratio of a number of the hot layers to the cold thick layers is 33:5, and a ratio of the number of the hot layers to the cold thin layers is 33:29.

6. The heat exchanger assembly of claim 4, wherein the cold thick layers comprise a plurality of cold thick fins, the cold thin layers comprise a plurality of cold thin fins, and a ratio of a cold thick fin thickness to a cold thin fin thickness is between 2.29 and 2.74.

7. The heat exchanger assembly of claim 6, wherein the hot layers comprise a plurality of hot fins, a ratio of the cold thick fin thickness to a hot fin thickness is between 4.33 and 5.86, and a ratio of the cold thin fin thickness to the hot fin thickness is between 1.66 and 2.43.

8. The heat exchanger assembly of claim 1, further comprising:
parting sheets separating the hot layers and the ram air layers;
a pair of end sheets that define the no flow length;
a pair of hot closure bars coupled to the hot layers that define the effective cold flow length;
a pair of cold closure bar coupled to the ram air layers that define the effective hot flow length; and
wherein the hot layers and the ram air layers comprise a plurality of ruffled fins.

9. The heat exchanger assembly of claim 1, further comprising:
a hot inlet configured to receive engine bleed air;
a hot outlet configured to provide a cooled flow to an air separation module of the inert gas system; and
wherein the ram air inlet flange is configured to receive an intermediate ram air flow from an environmental control system heat exchanger pack and the ram air outlet flange is configured to provide an outlet flow to a ram outlet header.

10. A heat exchanger core for a heat exchanger assembly of an inert gas system, the heat exchanger core comprising:
a fin assembly comprising a plurality of hot layers and ram air layers, the hot layers having an effective hot flow length, the ram air layers having an effective cold flow length, and the fin assembly having a no flow length, wherein a ratio of the effective hot flow length to the effective cold flow length is between 9.23 and 10.32 and a ratio of the no flow length to the cold flow length is between 21.86 and 25.23.

11. The heat exchanger core of claim 10, wherein the hot layers comprise a plurality of hot fins, the ram air layers comprise a plurality of cold fins, and a ratio of cold fin height to a hot fin height is between 1.65 and 1.77.

12. The heat exchanger core of claim 10, wherein the hot layers comprise a plurality of hot fins having a hot fin distribution density, the ram air layers comprise a plurality of cold fins having a cold fin distribution density, and a ratio of the hot fin distribution density to the fin cold distribution density is 13:8.

13. The heat exchanger core of claim 10, wherein the ram air layers comprise a plurality of cold thin layers and cold thick layers, and a ratio of a number of the cold thin layers to the cold thick layers is 29:5.

14. The heat exchanger core of claim 13, wherein a ratio of a number of the hot layers to the cold thick layers is 33:5, and a ratio of the number of the hot layers to the cold thin layers is 33:29.

15. The heat exchanger core of claim 13, wherein the cold thick layers comprise a plurality of cold thick fins, the cold thin layers comprise a plurality of cold thin fins, and a ratio of a cold thick fin thickness to a cold thin fin thickness is between 2.29 and 2.74.

16. The heat exchanger core of claim 15, wherein the hot layers comprise a plurality of hot fins, a ratio of the cold thick fin thickness to a hot fin thickness is between 4.33 and 5.86, and a ratio of the cold thin fin thickness to the hot fin thickness is between 1.66 and 2.43.

17. The heat exchanger core of claim 10, further comprising:
parting sheets separating the hot layers and the ram air layers;
a pair of end sheets that define the no flow length;
a pair of hot closure bars coupled to the hot layers that define the effective cold flow length;
a pair of cold closure bar coupled to the ram air layers that define the effective hot flow length; and
wherein the hot layers and the ram air layers comprise a plurality of ruffled fins.

18. A method of installing a heat exchanger assembly for an inert gas system in a ram air cooling system comprising:
coupling a ram air inlet flange of the heat exchanger assembly to an environmental control system heat exchanger pack of the ram air cooling system;
coupling a ram air outlet flange of the heat exchanger assembly to a ram outlet header of the ram air cooling system;
coupling a hot inlet of the heat exchanger assembly to an inlet conduit configured to provide engine bleed air;
coupling a hot outlet of the heat exchanger assembly to an outlet conduit configured to provide a cooled flow from the engine bleed air to an air separation module of the inert gas system; and
wherein cooling of the engine bleed air is provided by a core of the heat exchanger assembly comprising a fin assembly of a plurality of hot layers and ram air layers, the hot layers having an effective hot flow length, the ram air layers having an effective cold flow length, and the fin assembly having a no flow length, wherein a ratio of the effective hot flow length to the effective cold flow length is between 9.23 and 10.32 and a ratio of the no flow length to the cold flow length is between 21.86 and 25.23.

19. The method of claim 18, further comprising:
installing a gasket between the ram air outlet flange and the ram outlet header prior to coupling the ram air outlet flange to the ram outlet header.

20. The method of claim 18, further comprising:
installing thermo insulation proximate to the hot inlet of the heat exchanger assembly.
